(19) United States
(12) Patent Application Publication
(10) Pub. No.: US 2024/0420680 A1
(43) Pub. Date: Dec. 19, 2024

(54) SIMULTANEOUS AND MULTIMODAL RENDERING OF ABRIDGED AND NON-ABRIDGED TRANSLATIONS

(71) Applicant: GOOGLE LLC, Mountain View, CA (US)

(72) Inventors: Te I, San Jose, CA (US); Chris Kau, Los Altos, CA (US); Jeffrey Robert Pitman, Santa Clara, CA (US); Robert Eric Genter, Belmont, CA (US); Qi Ge, Fremont, CA (US); Wolfgang Macherey, Sunnyvale, CA (US); Dirk Ryan Padfield, Seattle, WA (US); Naveen Arivazhagan, Mountain View, CA (US); Colin Cherry, Mountain View, CA (US)

(21) Appl. No.: 18/337,168

(22) Filed: Jun. 19, 2023

(51) Int. Cl. G10L 13/08; G10L 13/10; G10L 15/00; G10L 15/26

(52) U.S. Cl. CPC G10L 13/086; G10L 13/10; G10L 15/005; G10L 15/26; G10L 2013/105

(57) ABSTRACT

Implementations relate to a multimodal translation application that can provide an abridged version of a translation through an audio interface of a computing device, while simultaneously providing a verbatim textual translation at a display interface of the computing device. The application can provide these different versions of the translation in certain circumstances when, for example, the rate of speech of a person speaking to a user is relatively high compared to a preferred rate of speech of the user. For example, a comparison between phonemes of an original language speech and a translated language speech can be performed to determine whether the ratio satisfies a threshold for providing an audible abridged translation. A determination to provide the abridged translation can additionally or alternatively be based on a determined language of the speaker.

### BACKGROUND

In some instances, automated assistants, dedicated translation applications, and/or other applications can be utilized to facilitate communications between individuals that speak different languages. For example, assume a first user that speaks a first language and a second user that speaks a second language. First language spoken input of a first user can be processed, using first language or multilingual automatic speech recognition (ASR), to generate first language recognized text. The first language recognized text can be translated (e.g., using neural machine translation and/or other technique(s)) to corresponding second language text, and the second language text visually rendered and/or audibly rendered (e.g., using speech synthesis) to the second user. A similar process can be utilized to visually and/or audibly render first language text, to the first user, that corresponds to second language spoken input of the second user.

However, these communications interactions can be prolonged in various scenarios, which can lead to prolonged usage of the application(s) that facilitate the communications and/or prolonged usage of processor, memory, and/or other computational resource(s) utilized to facilitate the communications interactions. For example, a communication interaction can be prolonged due to delays in translation, due to delays in audible rendering of translated text, and/or due to audible rendering of the entirety of translated text.

These delays can be exacerbated due to the need for a receiving user to consume the entirety of the translated text before formulating a response. These delays can additionally or alternatively be exacerbated in situations where a length of translated text and/or a quantity of phonemes in translated text exceeds that of counterpart original spoken input. For example, spoken input in a first language may only last five seconds, but it may take seven seconds for a translated second language counterpart to be rendered via speech synthesis. This can be due to the first language spoken input being more concise (lengthwise and/or phoneme-wise) than the translated second language counterpart-which can be a function of differences between the first and second languages. Moreover, miscommunications can occur in circumstances in which each participant must look at their respective device during an interaction, rather than looking at the face of the other participant. In such instances, when a user must stare at their translation application, a participant can miss opportunities to rephrase their speech when the other participant reacts to their speech in an unexpected way and/or otherwise indicates they did not understand the speech.

### SUMMARY

Implementations set forth herein relate to an automated assistant or other application that can facilitate translating speech in a first language for a user that speaks a second language. The application can provide a textual translation at a display interface for the user while simultaneously providing an abridged audio translation at an audio interface for the user. In these and other manners, a user can listen to the abridged version of the translation while directing their gaze and/or attention to the person who is speaking and, optionally, reference the textual translation when further clarification is desired. In some implementations, providing the abridged audio translation can involve processing audio data and/or textual data to perform disfluency removal, which can condense translations to remove any inconsequential and/or redundant speech. Alternatively, or additionally, text summarization and/or sentence shortening or lengthening can be performed to further condense or extend any translations, such that a duration of playback of the abridged or extended audio translation can be suitable for a user involved in conversation. This can allow the user to interpret translated conversations that might otherwise be difficult to understand when their translation application is limited to verbatim textual translations. This can additionally or alternatively allow the user to give their undivided attention to a person who is speaking to them in another language, which can result in more streamlined conversations that consume less time and energy for each party involved, and any devices involved. This can additionally or alternatively allow for a duration of the audio translation to be the same or similar to (e.g., within 20% of, 10% of, or other threshold degree of) the corresponding spoken input being provided, which can enable communication between two or more users to be concluded more quickly due to shortening of time periods when a receiving user is still consuming an audio translation despite the corresponding spoken input of a speaking user having already concluded. For example, spoken input in a first language may only last five seconds, but it may take seven seconds for a non-abridged translated second language counterpart to be rendered via speech synthesis. Implementations disclosed herein can generate an abridged second language counterpart that can be rendered via speech synthesis in less than seven seconds (e.g., at or near five seconds), mitigating delay between the spoken input being completed and the speech synthesis of the corresponding abridged second language counterpart being concluded.

In some implementations, initiating the generation of two different translations can be based on a determined rate at which a person is communicating with a user and/or whether that rate satisfies, or does not satisfy, a threshold. In some implementations, the threshold can be based on an estimated rate that speech can be translated and/or otherwise processed by a computer for a given language, an estimated length for the conversation, an estimated length of any subsequent speech from a participant in the conversation, and/or any other suitable basis for setting a threshold. For example, a person can speak a first language at a variety of different rates, which can influence the quality of a verbatim translation because of limitations on buffering, processing bandwidth, etc. Additionally, differences between the first language and the second language (e.g., a preferred language of a user) can provide a basis for selecting a degree to which a translation should be abridged and/or an amount of scrutiny that should be applied to disfluency detection. For example, when the application detects a first language being spoken by the person, while also acknowledging that the user will prefer to listen in a second language, settings for each process for facilitating the textual translation and abridged audio translation can be selected accordingly. In some instances, when the first language is Japanese and the second language is English, a degree to which the first language speech is summarized for the abridged audio translation can be greater, relative to instances when the first language is German (e.g., a language that is more similar to English) and the second language is English.

In some implementations, properties of playback of the abridged audio translation can also be determined based on the first language of the person, the second language of the user, natural language content of speech, a topic of speech, a context of an interaction, a rate of speech of the person, a rate of speech-to-text for the first language, a rate of text-to-speech for second language audio, a preferred rate of speech for listening by the user, and/or any other setting that can affect playback of audio. For example, an estimate for a rate of speech-to-text processing (e.g., x words per minute) from a first language to a second language can be generated, and, optionally, another estimate for a rate of text-to-speech (e.g., y words per minute) for the second language can be generated. When one or more of these rates are relatively slow for a given interaction (e.g., relative to other words-per-minute values), the abridged audio translation can be shortened relative to other instances when these one or more rates (e.g., x, y, etc.) are not relatively slow. In some implementations, an amount of summarization and/or abridgement for each snippet of audio and/or speech can be dynamically adapted according to features of the conversation between the person and the user, available computational bandwidth of the application, and/or any other property that can influence translations by an application. For example, natural language content embodied in the second language translation can be based on the degree of summarization, which can be based on the rate at which the user is speaking in the first language, a setting controlled by the user, topic(s) being discussed by the person or the user, and/or any other suitable basis for adjusting content provided for text-to-speech (TTS)/speech synthesis. In some implementations, scrolling of text rendered at the display interface can be performed at a rate that is based on the rate at which the one or more participants to a conversation are speaking, thereby allowing a user to reference non-abridged text of a translation without having to manually scroll through text of the translation. In some implementations, the display interface can be lenses of computerized glasses, which can simultaneously provide abridged audio translation and non-abridged visual translation to the user during the translation of the conversation.

The above description is provided as an overview of some implementations of the present disclosure. Further description of those implementations, and other implementations, are described in more detail below.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s))) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A, FIG. 1B, and FIG. 1C illustrate views of a user employing an application that generates an abridged translation of speech that can be audibly rendered for a user in real-time, while an unabridged translation of the speech is optionally rendered at a display interface for the user.

FIG. 2 illustrates a system that includes an application for processing audible speech to provide abridged and/or unabridged versions of any translated speech for a user.

FIG. 3 illustrates a method that allows a user to receive an audible, abridged version of translated speech in real-time while simultaneously, and optionally, being provided with a visual rendering of a literal translation of the speech.

FIG. 4 is a block diagram of an example computer system.

### DETAILED DESCRIPTION

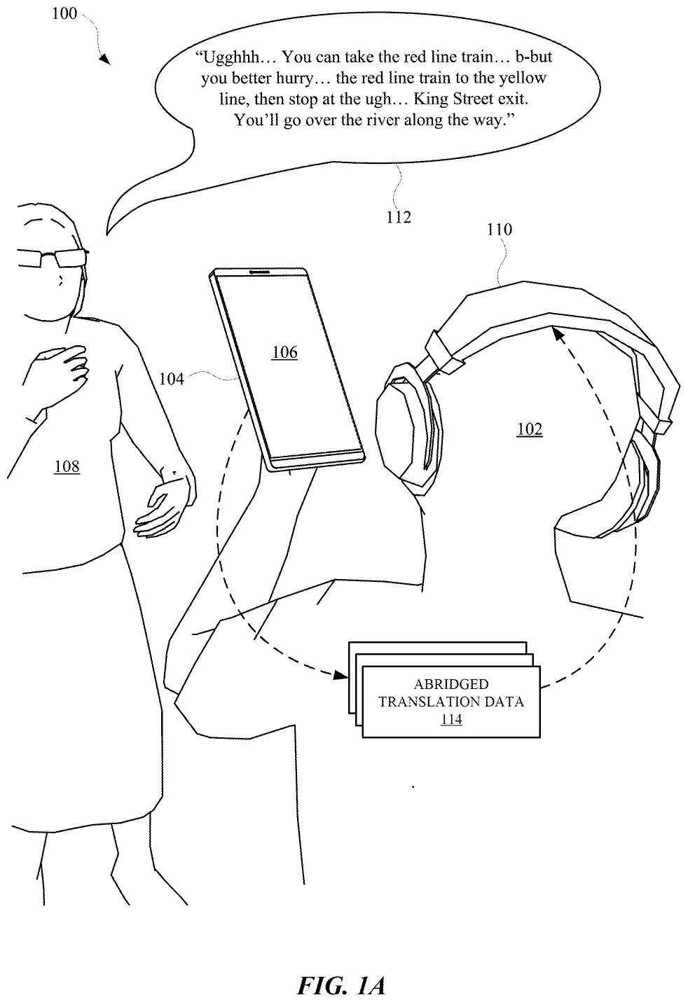

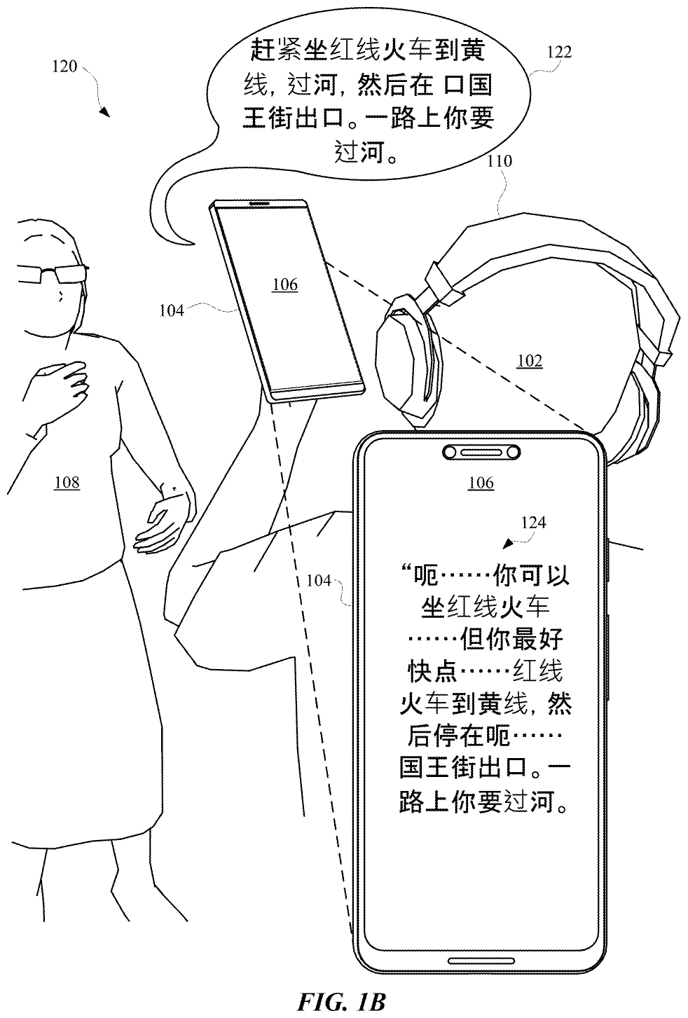

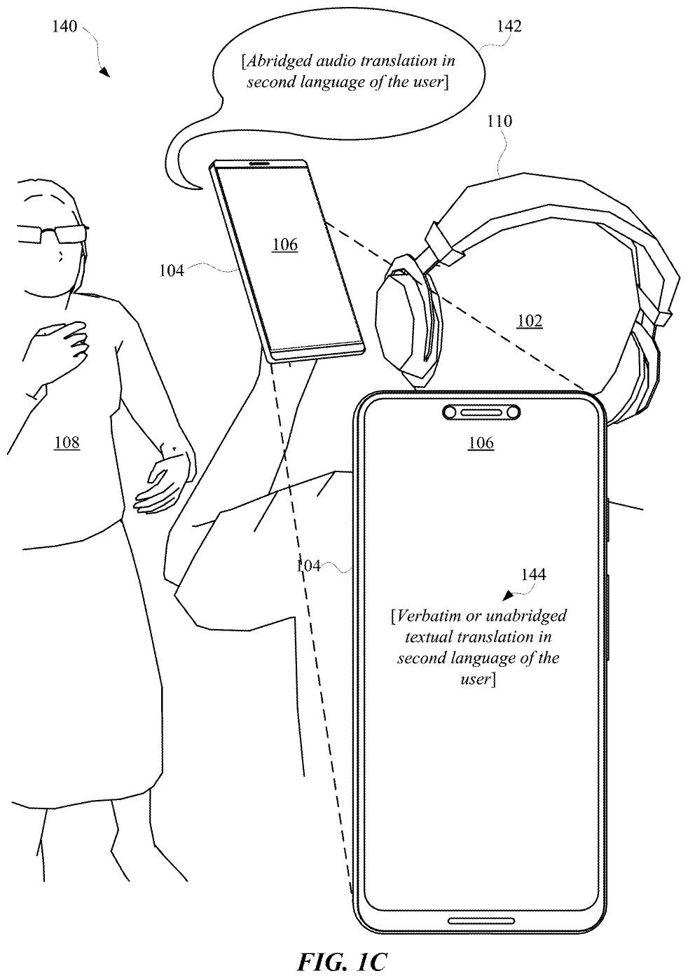

FIG. 1A, FIG. 1B and FIG. 1C illustrate views of a user 102 employing an application that generates an abridged translation of speech that can be audibly rendered for the user 102 in real-time, while an unabridged translation of the speech is optionally rendered at a display interface 106 for the user 102. For example, FIG. 1A includes a view 100 of a circumstance in which a person 108 (e.g., a tour guide) is communicating with the user 102 in a language (e.g., English) that is foreign to the user 102. For example, the user 102 may have requested directions from the person 108, while traveling in a foreign location, such as Washington, D.C., and the user 102 may wish to receive the directions in a preferred language (e.g., a Chinese language). In response, the person 108 may provide English speech 112 with directions, but the speech may contain disfluencies. These disfluencies may be of a stuttering type, such as repeating or prolonging some sounds or syllables (e.g., “b-but?”), repetitions of certain words within a sentence, false starts (e.g., “Ugh . . . You can . . . ”), stopping in the middle and starting all over again differently, etc. Other forms of disfluencies can include filler words, which may be used to fill pauses in the speech (e.g., “um,” “ugh,” “well,” etc.), and/or interjections aiming to either express a specific emotion or simply interrupt someone else's speech (e.g., “oh,” “ah,” “wow,” etc.).

The user 102 can operate a computing device 104, that can capture the English speech 112 as audio data for processing by a multimodal translation application (e.g., an assistant application or other interactive application), which can perform a variety of processing operations using the audio data. The application can render a textual translation of the speech of the person 108 for the user 102 using the display interface 106 of the computing device 104. The user 102 can also be provided with an audio playback translation of the English speech 112, which can be abridged relative to the textual translation. For example, disfluency detection and removal can be performed based on the audio data and/or the textual translation, and/or any other processing operations that can be performed by an application and/or according to the preferences of the user 102.

The textual translation 124 that is rendered at the display interface 106 can contain the detected disfluencies, as shown in view 120 of FIG. 1B, while the audio interface 110 can render an abridged audio playback translation 122. Abridging the audio playback translation can ensure that any conversation in real-time between the user 102 and the person 108 can be understood without any unnecessary pauses and/or wasting of resources, such as time, battery life, processing bandwidth, etc. Furthermore, providing the audio playback translation 122 allows the user 102 to maintain eye-contact with the person 108, thereby providing a more positive experience with each foreign conversation. In some implementations, the user 102 can manually (e.g., via a GUI element), or the application can adaptively, adjust some parameters, such as the speed of the audio playback translation and/or a relative length of each audio snippet (e.g., more or less detailed, depending on the situation) according to features of the conversation, the context, and/or a preference of the user 102. Such adaptations can occur during a particular conversation based on feature(s) of the conversation and/or on a per-conversation by per-conversation basis based on feature(s) of the respective conversation(s).

As illustrated in view 140 of FIG. 1C, the application can provide the user 102 with an abridged audio playback translation 142 that will be audibly rendered on the audio interface 110 (e.g., earbuds, headphone, speaker, etc.), allowing the user 102 to keep up with the conversation with anyone speaking a foreign language that is recognized by the application. Simultaneously, the user 102 will also be able to optionally check the unabridged verbatim textual translation 144 from the display interface 106 of the computing device 104, should a full literal translation be needed. Such circumstances can arise when the user 102 wants to reference the verbatim translation for clarifying and/or confirming their understanding of the abridged audio playback translation 142. Alternatively, or additionally, a gaze of the user 102 can be detected by processing one or more camera images (with prior permission from the user), and when the user 102 is determined to be directing their gaze towards the display interface, the non-abridged textual translation can be rendered at the display interface 106. Otherwise, the display interface 106 can optionally operate in a low power mode or otherwise not be responsive to the person 108 speaking.

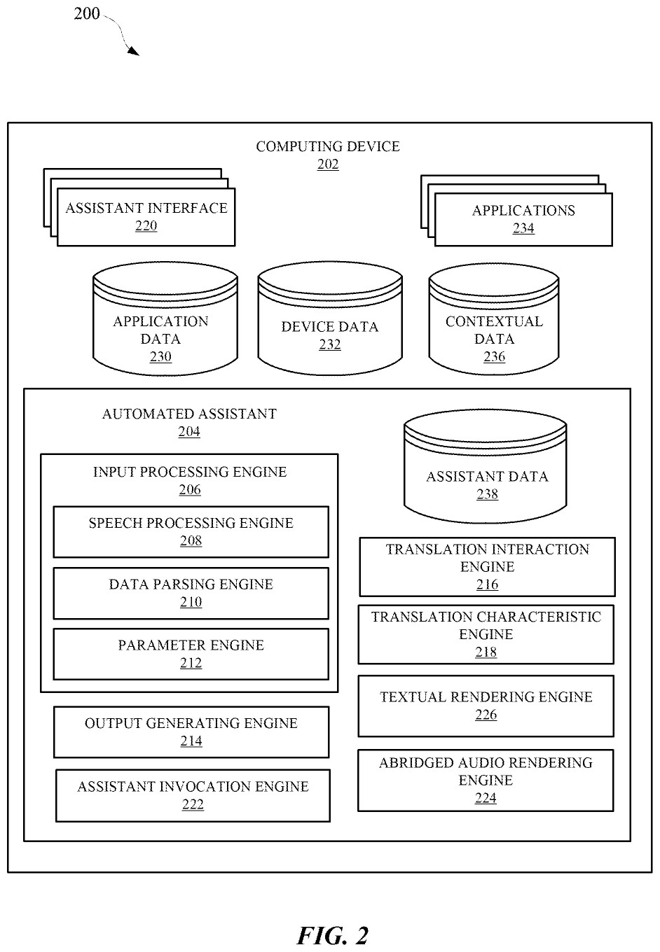

FIG. 2 illustrates a system 200 that includes an application and/or automated assistant 204 that can provide an abridged audio playback of a translation of foreign speech simultaneous to rendering a non-abridged version of the translation at a display interface. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a translation interaction engine 216 that can manage translation processes and/or any other interactions between the user, a bystander, and/or the system 200. For example, the translation interaction engine 216 can act as a mediator between the different components involved in the translation process, including a speech recognition module, a translation engine, a text-to-speech synthesis module, and/or an audio playback module. In some implementations, the translation interaction engine 216 can receive the audio input of a user or other participant (with prior permission), previously captured by a computing device 104, before performing a language detection of this audio input. A preprocessing stage can be conducted to enhance the audio quality and/or remove any background noise, using techniques such as audio normalization, echo cancellation, and/or noise filtering. The preprocessed audio input can be then analyzed using speech recognition to recognize and convert any spoken words from audio to text. Such conversion can be performed using techniques such as automatic speech recognition (ASR), which can involve the use of machine learning tools such as hidden Markov models, neural networks, and/or deep learning algorithms. The text output from speech recognition can optionally be then analyzed to detect the language of the spoken input. Language identification can be performed using language models, character n-grams, and/or statistical models to identify the language of the text. When the language of the spoken input has been detected, the translation interaction engine 216 can use machine translation to translate the spoken input into the target language, using techniques such as neural machine translation, rule-based translation, and/or statistical translation.

In some implementations, a machine translation process performed by the translation interaction engine 216 can send a translation request for a selected translation, providing the detected language of the spoken input and the target language. The translation system can then process the input text and generate a translation output in the target language. The translation interaction engine 216 can then receive the translation output and provide the translation output to the user through the display interface and/or the audio interface. In some implementations, the translation interaction engine 216 can display the translated data on the user interface either directly or after performing TTS synthesis. Additionally, the translation interaction engine 216 can abridge the translated text into shorter text (i.e., translated speech data) that would be played back as an abridged audio translation, or into longer text that would be played back as an extended audio translation (e.g., to account for contextually relevant breaks in speech such, for laughter, gestures, and/or any other breaks to be accounted for to promote fluid conversation). For example, the translation interaction engine 216 can use a text summarization algorithm and/or text summarization machine learning model(s) to generate a summary of the non-abridged translated speech data, which would be based on various techniques, such as extractive summarization and/or abstractive summarization. For example, the translation interaction engine 216 can generate a summary of the non-abridged translated speech data by processing the non-abridged translated speech data utilizing a large language model (LLM), optionally conditioned with certain text such as “summarize”, “condense”, “shorten [ ] to X words”, “shorten [ ] to Y phonemes”, “condense [ ] Z %”, etc. In some implementations, a degree of summarization for providing an abridged version of a translation can be manually controlled by a user (e.g., via a GUI interface) and/or through automatic selection by the application for a given context, user, and/or other feature of a given conversation.

In extractive summarization, the algorithm selects the relevant sentences or phrases from original text to form a summary. Techniques used in extractive summarization can optionally include frequency analysis, cosine similarity, and/or graph-based methods. In contrast with extractive summarization, in abstractive summarization, the algorithm generates a summary that can include new phrases or sentences not present in the original text. Techniques used in abstractive summarization involve deep learning models such as recurrent neural network(s) (RNN(s)), transformer(s) (e.g., LLM(s)), and/or pointer-generator networks. The abridged summary can then be synthesized into an abridged audio translation using text-to-speech (TTS) synthesis techniques. In some implementations, a TTS process can use either rule-based and/or machine learning-based approaches to generate speech from text (e.g., phonemes corresponding to the text). For example, a rule-based TTS process can use pre-defined pronunciation rules and synthesis algorithms, and a machine learning-based TTS process can use neural networks to generate synthesized speech by processing corresponding text.

When an abridged audio translation has been generated, this abridged translated audio can be played back to the user through an audio interface, which can allow the user to listen to a shorter summary of the translated text while still paying attention to the speaker and/or optionally checking the displayed non-abridged translation, for clarity. In some implementations, the translation interaction engine 216 can also manage user interactions by choosing the target language, adjusting parameters of the audio playback, and/or adjusting the length and/or the tone of the obtained textual translation. The translation interaction engine 216 can also provide a list of supported languages, and narrow down the possibilities of the detected spoken language using natural language processing (NLP) techniques, and/or allowing the user to select the target language for translation using the user interface. Through this interface, the user can also adjust the speed of the audio playback, which may be accomplished through audio manipulation techniques (e.g., adjusting certain parameters such as time scaling and pitch shifting). In some implementations, a more detailed textual translation of the spoken input can be generated by the translation interaction engine 216 as well, using context-aware language modeling and/or other phrase-based machine translation techniques, depending on the preferences of the user.

In some implementations, the system 200 may include a translation characteristic engine 218 that would manage the translation quality and characteristics of a translation. The translation characteristic engine 218 can analyze and evaluate various aspects of the translation output, such as accuracy, fluency, readability, coherence, and/or provide feedback and recommendations to improve the quality of any translation output. For example, the translation characteristic engine 218 can evaluate the quality of the translation output (text translation and/or audio translation) based on various metrics. In some implementations, a metric can include a word error rate (WER), which can characterize the accuracy of the translation output by indicating (e.g., using techniques such as dynamic time warping and/or Levenshtein distance) a percentage of words that are incorrectly translated and/or not translated at all (e.g., as determined based on user feedback provided for a translation). Another metric can include a language model perplexity, which can indicate fluency and/or coherency of the translation output. In some implementations, techniques such as n-gram language modeling or recurrent neural networks can be utilized to determine fluency and/or coherency (e.g., how well a language model predicts the next word in a sentence based on the previous words). In some implementations, readability scores can also quantify the quality of the translation, by assessing the clarity and comprehensibility of written material, and/or using techniques such as the Flesch-Kincaid readability test and/or the Gunning fog index.

In some implementations, the translation characteristic engine 218 can also analyze the translation output for various characteristics such as grammar and vocabulary according to different techniques. For example, part of speech tagging (POS) would allow to analyze the grammar and syntax of the translation output, by labeling each word in a sentence with a corresponding POS (e.g., noun, verb, adjective, etc.) using techniques such as Hidden Markov Models and Conditional Random Fields. Another example would be performing vocabulary analysis, by comparing the translation output to a bilingual lexicon for example, to identify any errors or inconsistencies in the vocabulary and ensure that the words are appropriate and accurate. In some implementations, the translation characteristic engine 218 can rely on word embeddings and term frequency-inverse document frequency (TF-IDF) for vocabulary analysis. The translation characteristic engine 218 can also analyze the style of the translation output to ensure that the style of the translation output is consistent with any intended tone, using techniques such as sentiment analysis. Alternatively, or additionally, grammar analysis can be performed using parsing techniques, such as dependency parsing and/or constituency parsing, in furtherance of ensuring the translation output is grammatically correct.

In some implementations, the translation characteristic engine 218 can combine the various metrics and generate an overall quality score for the translation output using a weighted scoring system. The weights can be assigned based on the importance of each metric for the particular application and/or domain. For example, weighted scoring can allow the system 200 to provide feedback to the translation interaction engine 216 based on the overall quality score, in order to improve the translation model by adjusting the weights and/or updating the language model. Additionally, or alternatively, the weighted scoring can provide some recommendations to improve the translation quality as well, such as suggesting alternative translations or tones, and/or pointing out ambiguities or other errors.

In some implementations, the system 200 can include a textual rendering engine 226 that can control the display of the translated text on a user interface. The textual rendering engine 226 can take the translated text output and render this translated text output in a user-friendly format at, for example, the display interface 106. The textual rendering engine 226 can optionally format the translated text in a user-friendly format, which can involve editing a variety of parameters, such as the font size, style, and/or color of the text. The textual rendering engine 226 can also add other formatting elements if necessary, such as spaces, line breaks, and headings. In some implementations, the textual rendering engine 226 can adapt the rendered text to the user interface, depending on different features of the display interface 106, such as the display size and resolution. Additionally, or alternatively, the textual rendering engine 226 can provide the user with options for customizing the display of the translated text, such as adjusting the font size and color, and/or choosing a different language display mode. In some implementations, the user can have the option to reference the textual translation when needed by interacting with a touch interface of a computing device and/or providing any other input to a device. For example, a gaze of the user can be detected (with prior permission of the user) by a camera of the computing device and, when the gaze of the user is directed towards the display interface, the textual translation can be rendered.

In some implementations, the system 200 can include an abridged audio rendering engine 224 that can generate and/or cause playback of the abridged audio translation. The abridged audio rendering engine 224 can utilize one or more text summarization techniques to reduce the length of the translated text, while keeping important details and/or summarizations. For example, the abridged audio rendering engine 224 can utilize extractive summarization and/or abstractive summarization. In some implementations, the abridged audio rendering engine 224 can perform disfluency detection and removal from the translated text, using natural language processing techniques such as, but not limited to, POS tagging, dependency parsing, and/or named entity recognition. These techniques can be utilized to identify disfluencies such as stuttering, false starts, and/or repetitions. In some implementations, disfluency detection can be performed using regular expressions by searching for patterns of disfluencies, and optionally further training machine learning models to recognize disfluencies within a given text. When identified, a disfluency removal process and/or correcting process can be performed according one or more heuristic processes, machine learning approaches, statistical methods, and/or any other suitable approach.

In some implementations, the abridged audio rendering engine 224 can convert abridged text into an audio file, using text-to-speech (TTS) synthesis technology, thereby creating an audio translation with a synthetic voice for the audio playback. In some implementations, the abridged audio rendering engine 224 can provide audio-editing tools, allowing a user to adjust the speed, volume, and/or pitch of the audio playback to match the preferences of the user and/or otherwise ensure the synthesized speech is clear and understandable. The abridged audio rendering engine 224 can optionally encode the synthesized speech into a format (e.g., MP3, ACC, etc.) that is suitable for playback on a device and/or transfer to another device. Although a series of models, or cascade of systems, can be utilized to convert an audio speech input to an abridged audio output, the system 200 can also employ a single model or system to convert an instance of input audio speech data to abridged audio output data according to any suitable language model.

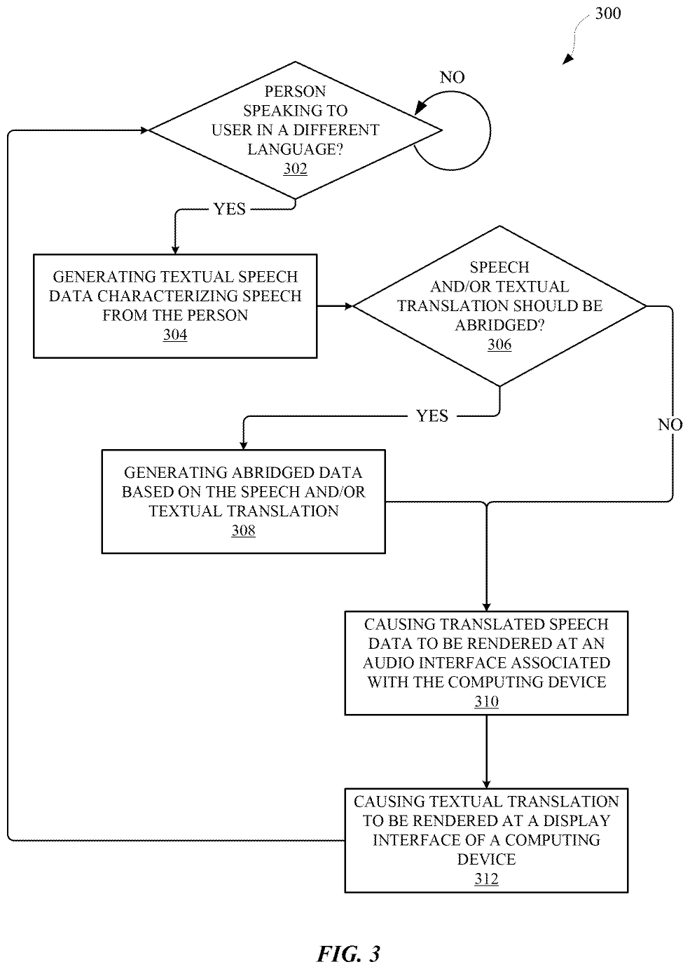

FIG. 3 illustrates a method 300 for providing an abridged translation of speech as audio for a user, while simultaneously, and optionally, providing a literal translation of the speech at a display interface for the user. The method 300 can be performed by one or more computing devices, applications, and/or any other apparatus or module that can be associated with an automated assistant. The method 300 can include an operation 302 of determining whether the person interacting with the user is speaking in a language that is foreign to the user. The process of determining whether the conversation is in a foreign language can be done using various methods. For example, the system can determine the language being spoken using speech recognition techniques by analyzing the captured input speech and matching the recognized speech with pre-existing language models. In some implementations, the recognized speech can be matched with an existing language model using techniques such as, but not limited to: Hidden Markov Models (HMMs) for detecting and recognizing phonemes, words, or sentences; Deep Neural Networks (DNNs) for modeling and matching the speech input with the corresponding language output; Gaussian Mixture Models (GMMs) for modeling the distribution of acoustic features of speech sounds based on statistical and/or probabilistic criteria; and/or using Convolutional Neural Networks (CNNs), in addition to modeling and matching speech sounds with Recurrent Neural Networks (RNNs).

In some implementations, language identification algorithms can be utilized to analyze the linguistic features of the spoken input, such as the phonetic structure, grammar, and vocabulary, to determine the language being spoken. This can involve statistical models and/or machine learning algorithms that have been trained on large datasets of spoken language. Alternatively, or additionally, determining the language being spoken can be based on contextual information such as the current location of the user, which can narrow down the list of possible languages to the commonly spoken languages in that particular geographical location. Alternatively, the user can manually specify the language of interest, and such input can be utilized to further train any relevant models, with prior permission from any involved parties.

When the recognized audio speech is determined to be in a foreign language, the method 300 can proceed from the operation 302 to an operation 304. The operation 304 may include generating textual speech data that characterizes the recognized speech from the person interacting with the user. Otherwise, the operation 302 can optionally be performed until speech audio data is recognized as being of a foreign language. In some implementations, the operation 304 can include using Automatic Speech Recognition (ASR) to convert spoken language into written text using machine learning algorithms. For example, ASR can include preprocessing an audio input to a computing device, which captures the speech from the person with whom the user is interacting. The preprocessing operation can remove noise, enhance the audio, and/or normalize the volume of the audio input data such that further extraction of audio features can be performed. In some implementations, one or more acoustic model (e.g., Hidden Markov Models (HMMs), Gaussian Mixture Models (GMMs), and Deep Neural Networks (DNNs)) can be used to map the audio features into the corresponding units of sound for a language, such as phonemes. When the phonemes have been mapped, a language model can be utilized to generate the most probable sequence of words given the phoneme sequence generated by the acoustic model. For example, candidate sequences can be generated using statistical models, such as n-grams, or neural network models, such as Recurrent Neural Networks (RNNs) and/or Transformers. In some implementations, any recognized text can be rendered for the user in real-time, thereby allowing a recipient of the speech, and user of the application, to reference a literal translation of the speech from the other person.

When textual speech data has been generated for characterizing the speech of the person the user is interacting with, the method 300 can proceed from the operation 304 to an operation 306. The operation 306 can include determining whether an obtained translation (in audio and/or textual format) of the textual speech data should be abridged. In some implementations, the operation can include determining whether an abridgement will be utilized, or not, based on a desired length of the text and/or a desired speed of the audio playback that would ensure a reasonable conversation pace in real-time. For example, the operation 306 can include determining whether the translated text needs to be abridged by estimating the time that would be needed to play back the entire translated text at the preferred pace of the user, and comparing that estimated audio translation time to an available time for playback. When the estimated time needed for full audio playback of the translation exceeds the available time, the translated text can be abridged by the application. In some implementations, the available time can be based on an estimate or prediction of subsequent speech from the person or user. Alternatively, or additionally, the available time can be estimated based on a topic of conversation and/or other contextual data. For example, one or more models utilized to estimate the available time can be trained using data that reflects conversations about directions to a location are typically shorter than conversations about more personal matters (e.g., family, friends, employment, etc.), or when the application is being used to assist a call-center employee.

Alternatively, or additionally, natural language processing (NLP) techniques can be utilized to summarize translated text. For example, NLP can involve analyzing the content of the text and identifying information, on which the creation of a summary would be based. Some NLP techniques can include Latent Semantic Analysis (LSA), TextRank, and/or Latent Dirichlet Allocation (LDA). Alternatively, or additionally, the application can allow the user to manually set some summarization parameters (e.g., using an interactive GUI element such as a dial or button), such as a desired length of the abridged text, and/or seeking feedback from the user about the quality of the obtained summary. This feedback can then be utilized to enhance any available learning algorithms, thereby allowing the application to learn from the previous actions and/or queries of the user, and adjust any model parameters accordingly.

When creation of a textual and/or audio abridgement is bypassed (i.e., a “no” decision at operation 306), the method 300 can proceed from the operation 306 to an operation 310 and/or to an operation 312, without encountering operation 308. For example, in such a situation operation 310 can be performed and can include causing unabridged translated speech data to be rendered at an audio interface associated with the computing device. Also, in such a situation, operation 312 can additionally or alternatively be performed, and can include causing an unabridged textual translation to be visually rendered at a display interface of a computing device. For example, a textual rendering engine 226 can convert the translated text into a visual format that can be displayed on the display interface using available formatting and/or rendering techniques. In some implementations, and optionally depending on a preference of the user, the text formatting process can involve a variety of operations, such as breaking the text into paragraphs, sentences, and/or individual words, in addition to properly adjusting punctuation using techniques such as sentence segmentation and/or text tokenization.

When the text has been formatted, the textual rendering engine 226 can optionally indicate a layout of the text for the display interface, by specifying some display parameters such as the font size and/or the alignment of the text. In some implementations, the textual rendering engine 226 may use techniques such as word wrapping, line breaking, and/or text justification to achieve a desired layout. In some implementations, the display rendering can be performed using one of the various graphics libraries such as OpenGL and Vulkan, and/or by applying web technologies such as HTML, CSS, and JavaScript. When the textual translation has been successfully rendered and displayed at operation 312 and/or the translated speech data has been rendered at the audio interface at operation 310, the method 300 can proceed back to the operation 302 for determining whether any additional speech should be translated.

When translation abridgement is determined to be performed (i.e., a “yes” decision at operation 306), the method 300 can proceed from the operation 306 to an operation 308 of generating abridged data, based on the speech and/or textual translation. The abridged data generated at operation 308 can include abridged speech data to be audibly rendered at operation 310 and/or an abridged textual translation to be visually rendered at operation 312. In some implementations, generating the abridged data can include extractive summarization, which can be performed by identifying and selecting the certain sentences and/or phrases from a relatively longer piece of text to create a shorter summary that conveys main ideas. In some implementations, summarization can be performed first using techniques such as keyword extraction, sentence clustering, and/or named entity recognition for the identification process, and then using a selection process by defining certain criteria such as sentence length, keyword frequency, and/or relevance to a topic. Thereafter, when abridged speech data is generated at operation 308 using text-to-speech (TTS) synthesis techniques, the application can convert the selected sentences into speech data, which can involve using pre-recorded voice samples and/or generating synthetic voices based on machine learning algorithms. Additional disfluency verification and processing can optionally be performed before adjusting the speed and/or intonation of the synthesized speech data to ensure a natural-sounding playback audio translation.

When translation abridgement is performed at operation 308, the method can still proceed to operation 310 and/or operation 312, but one or both of operation 310 and operation 312 will be performed based on abridged data (as opposed to unabridged data). As one example, when translation abridgement is performed at operation 308, operation 310 can be performed and can include causing abridged translated speech data to be audible rendered at an audio interface associated with the computing device. Optionally, in such an example operation 312 can also be performed and can include causing an unabridged textual translation to be rendered at a display interface of the computing device. Accordingly, in such an example abridged translated speech data is audibly rendered at operation 310 whereas an unabridged textual translation is visually rendered at operation 312. The rendering of the audible and visual translations can at least partially overlap temporally.

Audibly rendering the speech data at block 310 can involve a speech synthesis engine that converts text into spoken words using text-to-speech (TTS) synthesis and/or by converting the text into phonetic units that represent the sounds of the language, and then assembling those units into spoken words and/or phrases. TTS can also be employed to apply intonation, stress, and/or other prosodic features to make the speech sound more natural. For example, heuristic, concatenative, and/or statistical parametric methods can be utilized during TTS processing. In some implementations, heuristic-based TTS can be performed and rely on a set of linguistic rules to generate speech, while a concatenative-based TTS approach can use a database of recorded speech samples to assemble words and phrases. In some implementations, a statistical parametric TTS engine can use machine learning algorithms to train a model of speech that can generate speech from text. When the speech data is generated, an audio playback can be rendered via an audio interface associated with the computing device of the user. An audio playback engine can ensure smooth playback of the audio data by using techniques such as buffering and/or streaming. The audio playback engine can also allow the user to adjust the speed and/or volume of the audio playback, in addition to pause or resume playback as needed.

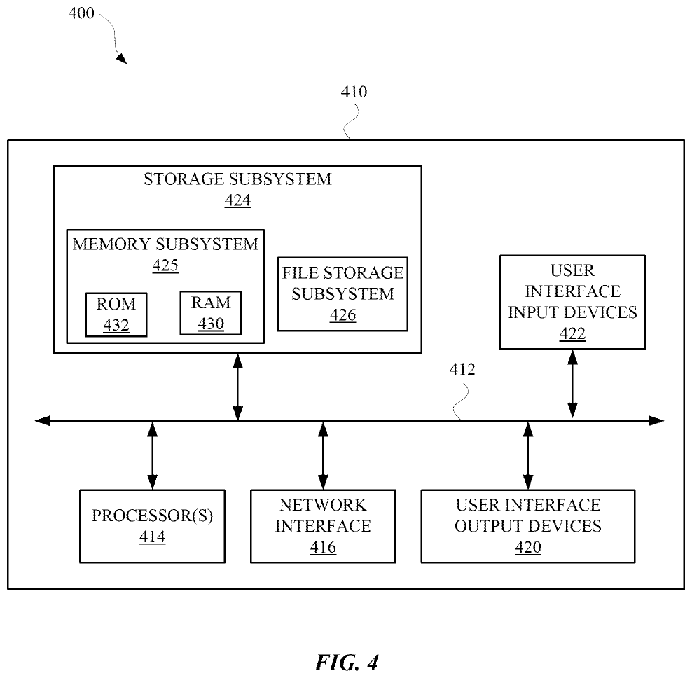

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by processor(s) is provided and includes determining that a person is speaking to a user in a first language that is different from a second language of the user. The method further includes generating, based on audio data characterizing first language speech from the person speaking to the user, non-abridged translated speech data that characterizes a non-abridged second language translation of the first language speech. The method further includes generating, based on the audio data and/or the translated speech data, abridged translated speech data that characterizes an abridged version of the second language translation. The method further includes (a) causing, based on the non-abridged translated speech data, a display interface of a computing device to visually render the non-abridged second language translation; and (b) causing, based on the abridged translated speech data, second language audio to be rendered via an audio interface of the computing device or an additional computing device. The second language audio includes synthesized speech of the abridged version of the second language translation.

These and other implementations of the technology can include one or more of the following features.

In some implementations, causing the audio interface to render the second language audio is performed simultaneous to the display interface of the computing device rendering the non-abridged second language translation. In some of those implementations, causing the display interface to render the non-abridged second language translation includes scrolling the non-abridged second language translation at the display interface at a rate that is based on a determined rate in which the person is speaking to the user.

In some implementations, the method further includes determining, based on image data captured by a camera of the computing device or the additional computing device, that the user is directing their gaze towards the display interface of the computing device. In some of those implementations, causing the display interface to render the non-abridged second language translation is performed in response to determining that the user is directing their gaze towards the display interface of the computing device.

In some implementations, generating the abridged translated speech data includes performing a disfluency removal process on the non-abridged translated speech data for identifying and removing disfluencies in the second language translation. In some of those implementations, the abridged translated speech data is generated based on a version of the second language translation with the disfluencies removed.

In some implementations, generating the abridged speech data includes determining a target length for the abridged version of the translation based on a detected rate with which the person is speaking in the first language. The duration of rendering the second language audio is based on the target length.

In some implementations, generating the abridged speech data includes determining a degree of summarization for the abridged version of the translation based on a detected rate with which the person is speaking in the first language. In some versions of those implementations, natural language content embodied in the second language audio is based on the degree of summarization. In some variants of those versions, determining the degree of summarization for the abridged version of the translation includes comparing the detected rate in which the person is speaking in the first language to one or more threshold values in furtherance of determining the degree of summarization for the abridged version, where the degree of summarization is greater for a higher detected rate of speaking relative to a lower detected rate of speaking. In some of those variants, the degree of summarization is based on an estimated total number of phonemes, characters, and/or words in the abridged version of the second translation relative to the non-abridged second translation.

In some implementations, generating the abridged speech data includes processing the non-abridged translated speech data using one or more large language models (LLMs) to generate abridged sentence text from unabridged sentence text characterized by the non-abridged translated speech data, where the abridged sentence data characterizes a summarization of the unabridged sentence text.

In some implementations, a method implemented by processor(s) is provided and includes determining that a person is speaking to a user in a first language that is different from a second language spoken by the user. The method further includes determining, based on processing audio data and/or video data that captures features of speech of the person, a rate of communication of the person to the user. The rate of communication indicates an estimated number of words or phonemes spoken by the person for a duration of time. The method further includes determining whether the rate of communication satisfies a rate threshold for providing, to the user, an abridged version of speech from the person. The method further includes, in response to determining that the rate of communication satisfies the rate threshold: (a) causing an audio output interface of a computing device to audibly render, in the second language, synthesized speech of the abridged version of the speech from the person; and (b) causing a display interface of the computing device or of a separate computing device to visually render a second language translation of the speech from the person.

These and other implementations of the technology can include one or more of the following features.

In some implementations, the rate threshold is a value that is based on an estimated rate of translating first language speech to second language text.

In some implementations, the rate threshold is a value that is based on an estimated rate of performing speech synthesis for the second language.

In some implementations, the method further includes, in response to determining that the rate of communication fails to satisfy the rate threshold, causing the audio output interface of the computing device to audibly render, in the second language, alternate synthesized speech of an unabridged version of the speech from the person.

In some implementations, the computing device or the separate computing device includes computerized glasses, and the display interface includes one or more lenses of the computerized glasses.

In some implementations, a method implemented by processor(s) is provided and includes determining, based on audio data captured by a computing device, that speech from a person to a user embodies a first number of phonemes embodied in a first language. The method further includes determining, based on the audio data, that a second language translation of the speech embodies a second number of other phonemes. The phonemes of the first language are different from the other phonemes of the second language. The method further includes processing the first number of phonemes, the second number of other phonemes, and/or the audio data in furtherance of determining whether to render, for the user, an abridged version of the second language translation or a non-abridged version of the second language translation. The method further includes, in response to determining to render the abridged version of the second language translation: (a) generating second language translation data that characterizes the abridged version of the second language translation and the non-abridged version of the second language translation, (b) causing the abridged version of the second language translation to be rendered at an audio interface for the user, and (c) causing the non-abridged version of the second language translation to be rendered, at a display interface for the user, simultaneous to the abridged version of the second language translation being rendered at the audio interface for the user.

These and other implementations of the technology can include one or more of the following features.

In some implementations, processing the first number of phonemes, the second number of other phonemes, and/or the audio data includes determining whether a difference between the first number of phonemes and the second number of phonemes satisfies a threshold for rendering the abridged version of the second language translation for the user. In some versions of those implementations, the method further includes determining the difference threshold based on the first language being spoken by the person and the second language that is spoken by the user. In some of those versions, the method further includes determining, based on processing the audio data and/or video data that captures features of the speech of the person, a rate of communication of the person to the user. The rate of communication indicates an estimated rate of phonemes spoken by the person for a duration of time, and, optionally, the difference threshold is further selected based on the rate of communication.

In some implementations, the method further includes, in response to determining to render the non-abridged version of the second language translation, generating other second language translation data that characterizes the non-abridged version of the second language translation, and causing the non-abridged version of the second language translation to be rendered at the audio interface for the user.

In some implementations, a method implemented by processor(s) is provided and includes: determining that a person is speaking to a user in a first language that is different from a second language of the user; generating, based on audio data characterizing first language speech from the person speaking to the user, non-abridged translated speech data that characterizes a non-abridged second language translation of the first language speech; generating, based on the translated speech data, abridged translated speech data that characterizes an abridged version of the second language translation; and causing, based on the abridged translated speech data, second language audio to be rendered via an audio interface of the computing device or an additional computing device. The second language audio includes synthesized speech of the abridged version of the second language translation.

In some implementations, a method implemented by processor(s) is provided and includes: determining that a person is speaking to a user in a first language that is different from a second language spoken by the user; determining, based on processing audio data and/or video data that captures features of speech of the person, a rate of communication of the person to the user, where the rate of communication indicates an estimated number of words or phonemes spoken by the person for a duration of time; determining whether the rate of communication satisfies a rate threshold for providing, to the user, an abridged version of speech from the person; and in response to determining that the rate of communication satisfies the rate threshold: causing an audio output interface of a computing device to audibly render, in the second language, synthesized speech of the abridged version of the speech from the person.

In some implementations, a method implemented by processor(s) is provided and includes: determining, based on audio data captured by a computing device, that speech from a person to a user embodies a first number of phonemes embodied in a first language; determining, based on the audio data, that a second language translation of the speech embodies a second number of other phonemes, where the phonemes of the first language are different from the other phonemes of the second language; processing the first number of phonemes, the second number of other phonemes, and/or the audio data in furtherance of determining whether to render, for the user, an abridged version of the second language translation or a non-abridged version of the second language translation; and in response to determining to render the abridged version of the second language translation: generating second language translation data that characterizes the abridged version of the second language translation and the non-abridged version of the second language translation, and causing the abridged version of the second language translation to be rendered at an audio interface for the user.

We claim:

1. A method implemented by one or more processors, the method comprising:
determining that a person is speaking to a user in a first language that is different from a second language of the user;
generating, based on audio data characterizing first language speech from the person speaking to the user, non-abridged translated speech data that characterizes a non-abridged second language translation of the first language speech;
generating, based on the audio data and/or the translated speech data, abridged translated speech data that characterizes an abridged version of the second language translation;
causing, based on the non-abridged translated speech data, a display interface of a computing device to visually render the non-abridged second language translation; and
causing, based on the abridged translated speech data, second language audio to be rendered via an audio interface of the computing device or an additional computing device,
wherein the second language audio includes synthesized speech of the abridged version of the second language translation.

2. The method of claim 1, wherein causing the audio interface to render the second language audio is performed simultaneous to the display interface of the computing device rendering the non-abridged second language translation.

3. The method of claim 2, wherein causing the display interface to render the non-abridged second language translation includes scrolling the non-abridged second language translation at the display interface at a rate that is based on a determined rate in which the person is speaking to the user.

4. The method of claim 1, further comprising:
determining, based on image data captured by a camera of the computing device or the additional computing device, that the user is directing their gaze towards the display interface of the computing device,
wherein causing the display interface to render the non-abridged second language translation is performed in response to determining that the user is directing their gaze towards the display interface of the computing device.

5. The method of claim 1, wherein generating the abridged translated speech data includes:
performing a disfluency removal process on the non-abridged translated speech data for identifying and removing disfluencies in the second language translation,
wherein the abridged translated speech data is generated based on a version of the second language translation with the disfluencies removed.

6. The method of claim 1, wherein generating the abridged speech data includes:
determining a target length for the abridged version of the translation based on a detected rate with which the person is speaking in the first language,
wherein a duration of rendering the second language audio is based on the target length.

7. The method of claim 1, wherein generating the abridged speech data includes:
determining a degree of summarization for the abridged version of the translation based on a detected rate with which the person is speaking in the first language,
wherein natural language content embodied in the second language audio is based on the degree of summarization.

8. The method of claim 7, wherein determining the degree of summarization for the abridged version of the translation includes:
comparing the detected rate in which the person is speaking in the first language to one or more threshold values in furtherance of determining the degree of summarization for the abridged version,
wherein the degree of summarization is greater for a higher detected rate of speaking relative to a lower detected rate of speaking.

9. The method of claim 8, wherein the degree of summarization is based on an estimated total number of phonemes, characters, and/or words in the abridged version of the second translation relative to the non-abridged second translation.

10. The method of claim 1, wherein generating the abridged speech data includes:
processing the non-abridged translated speech data using one or more large language models (LLMs) to generate abridged sentence text from unabridged sentence text characterized by the non-abridged translated speech data,
wherein the abridged sentence data characterizes a summarization of the unabridged sentence text.

11. A method implemented by one or more processors, the method comprising:
determining that a person is speaking to a user in a first language that is different from a second language spoken by the user;
determining, based on processing audio data and/or video data that captures features of speech of the person, a rate of communication of the person to the user,
wherein the rate of communication indicates an estimated number of words or phonemes spoken by the person for a duration of time;
determining whether the rate of communication satisfies a rate threshold for providing, to the user, an abridged version of speech from the person;
in response to determining that the rate of communication satisfies the rate threshold:
causing an audio output interface of a computing device to audibly render, in the second language, synthesized speech of the abridged version of the speech from the person; and
causing a display interface of the computing device or of a separate computing device to visually render a second language translation of the speech from the person.

12. The method of claim 11, wherein the rate threshold is a value that is based on an estimated rate of translating first language speech to second language text.

13. The method of claim 11, wherein the rate threshold is a value that is based on an estimated rate of performing speech synthesis for the second language.

14. The method of claim 11, further comprising:
in response to determining that the rate of communication fails to satisfy the rate threshold:
causing the audio output interface of the computing device to audibly render, in the second language, alternate synthesized speech of an unabridged version of the speech from the person.

15. The method of claim 11, wherein the computing device or the separate computing device includes computerized glasses, and the display interface includes one or more lenses of the computerized glasses.

16. A method implemented by one or more processors, the method comprising:
determining, based on audio data captured by a computing device, that speech from a person to a user embodies a first number of phonemes embodied in a first language;
determining, based on the audio data, that a second language translation of the speech embodies a second number of other phonemes,
wherein the phonemes of the first language are different from the other phonemes of the second language;
processing the first number of phonemes, the second number of other phonemes, and/or the audio data in furtherance of determining whether to render, for the user, an abridged version of the second language translation or a non-abridged version of the second language translation;
in response to determining to render the abridged version of the second language translation:
generating second language translation data that characterizes the abridged version of the second language translation and the non-abridged version of the second language translation,
causing the abridged version of the second language translation to be rendered at an audio interface for the user, and
causing the non-abridged version of the second language translation to be rendered, at a display interface for the user, simultaneous to the abridged version of the second language translation being rendered at the audio interface for the user.

17. The method of claim 16, wherein processing the first number of phonemes, the second number of other phonemes, and/or the audio data includes:
determining whether a difference between the first number of phonemes and the second number of phonemes satisfies a threshold for rendering the abridged version of the second language translation for the user.

18. The method of claim 17, further comprising:
determining the difference threshold based on the first language being spoken by the person and the second language that is spoken by the user.

19. The method of claim 18, further comprising:
determining, based on processing the audio data and/or video data that captures features of the speech of the person, a rate of communication of the person to the user,
wherein the rate of communication indicates an estimated rate of phonemes spoken by the person for a duration of time, and
wherein the difference threshold is further selected based on the rate of communication.

20. The method of claim 16, further comprising:
in response to determining to render the non-abridged version of the second language translation:
generating other second language translation data that characterizes the non-abridged version of the second language translation, and
causing the non-abridged version of the second language translation to be rendered at the audio interface for the user.
